(19) United States
(12) Patent Application Publication
(10) Pub. No.: US 2010/0232326 A1
(43) Pub. Date: Sep. 16, 2010

(54) MOBILE AD-HOC NETWORK HAVING INTERFERENCE MITIGATION AND RELATED METHODS

(75) Inventors: Fred C. KELLERMAN, Webster, NY (US); John W. Nieto, Rochester, NY (US); William Nelson Furman, Fairport, NY (US)

Correspondence Address: ALLEN, DYER, DOPPELT, MILBRATH & GILCHRIST, 255 S ORANGE AVENUE, SUITE 1401, ORLANDO, FL, 32801, US

(73) Assignee: Harris Corporation, Corporation of the State of Delaware, Melbourne, FL (US)

(21) Appl. No.: 12/400,982

(22) Filed: Mar. 10, 2009

(51) Int. Cl. H04L 12/28; H04B 7/00

(52) U.S. Cl. 370/310; 370/406

(57) ABSTRACT

A mobile ad-hoc network (MANET) may include mobile nodes establishing wireless communications links therebetween. The mobile nodes may communicate based upon an avalanche or relay communications protocol. Each mobile node may comprise a wireless transceiver, and a decorrelation filter cooperating therewith for reducing interference from other mobile nodes. For example, the decorrelation filter also reduces one or more of multi-path interference from other mobile nodes or narrow band interference from other sources.

### FIELD OF THE INVENTION

The present invention relates to the field of wireless communications, and, more particularly, to mobile ad-hoc network interference mitigation and related methods.

### BACKGROUND OF THE INVENTION

Wireless networks have experienced increased development in the past decade. One of the most rapidly developing areas is mobile ad hoc networks (MANETs). Physically, a MANET includes a number of geographically distributed, potentially mobile nodes sharing one or more common radio channels. Compared with other types of networks, such as, cellular networks or satellite networks, the most distinctive feature of MANETS is the lack of any fixed infrastructure. The network is formed of mobile (and potentially stationary) nodes, and is created on the fly as the nodes communicate with each other. The network does not depend on a particular node and dynamically adjusts as some nodes join or others leave the network.

A MANET is disclosed in U.S. Pat. No. 7,216,282 to Cain, assigned to the present application's assignee. The MANET may include a source node, a destination node, and a plurality of intermediate nodes. The source node may establish a plurality of routes to the destination node for transferring data therebetween, where each route passes through at least one of the intermediate nodes. The source node may also encode a plurality of data packets using a forward error correction (FEC) encoding algorithm to generate error correction data for the data packets, interleave the data packets and error correction data, and distribute and send the interleaved data packets and error correction data across the routes to the destination node. Furthermore, the destination node may receive and deinterleave the interleaved data packets and error correction data. The destination node may also decode the data packets based upon the error correction data using an FEC decoding algorithm to correct compromised data packets.

Another development in MANETs is disclosed in U.S. Pat. No. 7,085,290 to Cain et al., also assigned to the present application's assignee. Cain et al. discloses a MANET that may include a plurality of mobile nodes, each including a wireless communications device and a controller connected thereto. At an upper protocol layer, the controller may establish a quality-of-service (QoS) threshold. At an intermediate protocol layer, the controller may select at least one route for transmitting data to at least one destination mobile node based upon the QoS threshold, and determine whether a QoS metric for the selected route falls below the threshold. At a lower protocol layer, the controller may cooperate with the wireless communications device to transmit data to the at least one destination mobile node via the at least one selected route, and cooperate with the wireless communications device at the lower protocol layer to adjust signal transmission power, pattern, and/or gain based upon a determination that the QoS metric has fallen below the QoS threshold.

One example of a particularly advantageous communications protocol is an “avalanche” communication protocol, as first disclosed in U.S. Pat. No. 4,639,937 to McRae et al., also assigned to the present application's assignee. A typical “avalanche” relay communication network includes a plurality of transceiver stations spread out over a geographic area to establish spatial diversity among the stations. The transceiver equipment at each station has the capability of simultaneous transmission over the same frequency through a “common knowledge” network timing scheme, such as time division multiple access, and has the capability of taking advantage of received multipath signals. Communications between a source station and a destination station are achieved by the source station modulating onto a high frequency (HF) carrier (or other RF carrier bands, such as, the very high frequency (VHF) band and the ultra high frequency (UHF) band) a digital packet formatted to contain the number of times the message is to be repeated and a method of establishing the quality of the received message. All stations having correctly received the packet repeat that same message on the same carrier frequency at the same pre-established future absolute time. The typical “avalanche” relay communication network provides connectivity for an HF (or VHF, UHF, etc.) communication channel by a communication scheme that uses relay techniques to achieve path diversity without additional frequency allocation or instantaneous status information.

### SUMMARY OF THE INVENTION

In view of the foregoing background, it is therefore an object of the present invention to provide a mobile ad-hoc network (MANET) that has robust interference mitigation and improved throughput performance.

This and other objects, features, and advantages in accordance with the present invention are provided by a MANET comprising a plurality of mobile nodes establishing wireless communications links therebetween. The plurality of mobile nodes communicate based upon an avalanche communications protocol. Each mobile node may comprise a wireless transceiver, and a decorrelation filter cooperating therewith for reducing interference from other mobile nodes. The MANET may use a relay communications protocol that is advantageous for some applications but that may cause interference, and the MANET uses a decorrelation filter to mitigate this interference.

For example, each mobile node may communicate based upon an avalanche communications protocol. More specifically, the decorrelation filter may comprise an adaptive decorrelation filter. For example, the decorrelation filter also filters one or more of multi-path interference from other mobile nodes or narrow band interference from other sources,

In some embodiments, each mobile node may further comprise a downconverter upstream from the decorrelation filter for converting a received signal into a baseband signal. Also, each mobile node may further comprise a demodulator downstream from the decorrelation filter. For example, each mobile node may communicate based upon a Gaussian minimum shift keying (GMSK) protocol. Additionally, each mobile node may communicate based upon at least one of a voice relay protocol and a data relay protocol.

Another aspect is directed to a method of operating a MANET. The MANET may include a plurality of mobile nodes establishing wireless communications links therebetween. Each mobile node may comprise a wireless transceiver, and a decorrelation filter cooperating therewith. The method may include communicating via the plurality of mobile nodes based upon an avalanche communications protocol, and reducing interference from other mobile nodes with the decorrelation filter.

### BRIEF DESCRIPTION OF THE DRAWINGS

FIG. 1 is a schematic diagram of a mobile ad-hoc network (MANET) according to the present invention.

FIG. 2 is a graph of a received signal in a MANET according to the prior art.

FIG. 3 is an ideal frequency spectrum diagram for a receiver node in the MANET of FIG. 1.

FIG. 4 is another frequency spectrum diagram for a receiver node in a MANET using an avalanche communications protocol according to the prior art.

FIG. 5 is a frequency spectrum diagram for a receiver node in the MANET of FIG. 1.

FIG. 6 is a graph of error free packets versus relative signal-to-noise (SNR) for communications in the MANET of FIG. 1 and in the MANET according to the prior art.

### DETAILED DESCRIPTION OF THE PREFERRED EMBODIMENTS

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

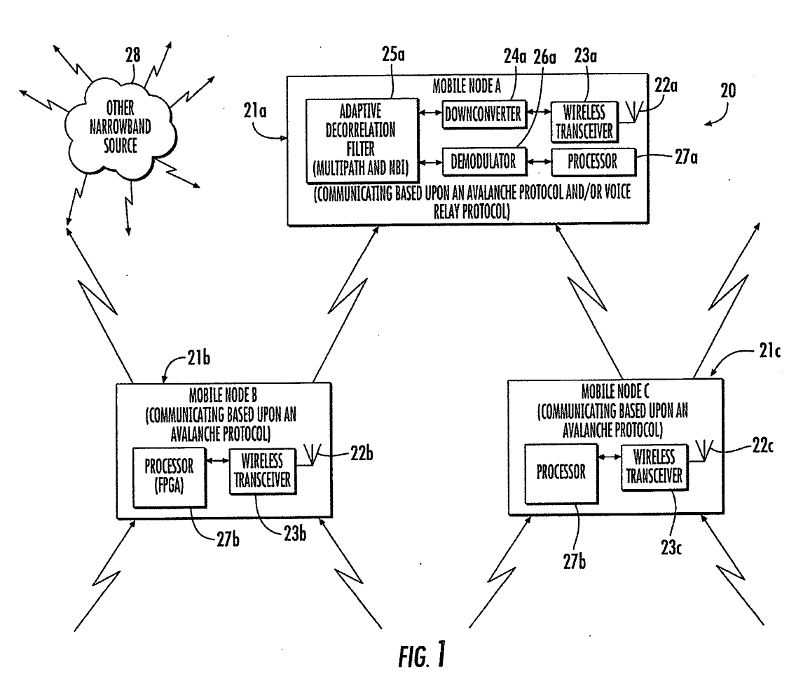

Referring initially to FIG. 1, a mobile ad-hoc network 20 (MANET) according to the present invention is now described. The MANET 20 illustratively includes a plurality of mobile nodes 21a-21c establishing wireless communications links therebetween.

As will be appreciated by those skilled in the art, the plurality of mobile nodes 21a-21c communicate based upon an avalanche communications protocol, as disclosed in U.S. Pat. No. 4,639,937 to McRae et al., also assigned to the present application's assignee, the contents of which are hereby incorporated by reference in their entirety.

Each mobile node 21a-21c illustratively includes a wireless transceiver 23a-23c, and an antenna 22a-22c coupled thereto. For example, each mobile node 21a-21c may be based upon an advanced networking wideband waveform (ANW2) MANET ManPack, Release 3.0, modified by the disclosure herein. The MANET ManPack is available from the Harris Corporation of Melbourne, Fla., the assignee of the present application.

For ease of illustration, only MANET node A 21a is shown in detail. Nonetheless, as will be readily appreciated by the skilled person in the art, the other nodes 21b-21c are similar. The mobile node 21a illustratively includes a downconverter 24a downstream from the wireless transceiver 23a for converting a received signal into a baseband signal, as will be appreciated by those skilled in the art.

Furthermore, the mobile node 21a illustratively includes an adaptive decorrelation filter 25a downstream from the downconverter 24a and cooperating with the wireless transceiver 23a for reducing interference from other mobile nodes 21b-21c. For example, the adaptive decorrelation filter 24a may comprise the decorrelation filter disclosed in co-pending U.S. patent application Ser. No. 11/871,174 to Furman et al., also assigned to the present application's assignee, the contents of which are hereby incorporated by reference in their entirety. In other embodiments, the decorrelation filter 25a may be a static decorrelation filter (instead of adaptive).

Also, the mobile node 21a illustratively includes a demodulator 26a downstream from the adaptive decorrelation filter 25a for demodulating the filtered received signal. The mobile node 21a illustratively includes a processor 27a downstream from the demodulator 26a, The wireless transceiver 23a, the downconverter 24a, the adaptive decorrelation filter 25a, the demodulator 26a, and the processor 27a may all advantageously be implemented with an ANW2 modem field-programmable gate array (FPGA) or could be implemented on a general purpose processor (GPP) or digital signal processor (DSP).

The MANET 20 may operate based upon a Gaussian minimum shift keying (GMSK) communications protocol, for example, GMSK Rake 16 and 32, as disclosed in U.S. Pat. No. 7,352,795 to Furman et al., also assigned to the present application's assignee, the contents of which are hereby incorporated by reference in their entirety. As will be appreciated by those skilled in the art, the MANET 20 may operate based upon other spread spectrum signaling schemes, such as M-ary phase shift keying (M-PSK). Additionally, the MANET 20 and the mobile nodes 21a-21c therein may communicate based upon at least one of a voice relay protocol and a data relay protocol. Advantageously, the adaptive decorrelation filter 25a can also reduce the multi-path interference from one or more mobile nodes 21b-21c or filter out narrow band interference 28 from other sources, for example, jammer devices.

For example, the decorrelation filter 25a can reduce the effects of multiple (close to simultaneous) avalanche or relay transmissions from other mobile nodes 21b-21c while also filtering narrow band interference signals from other sources, i.e. the illustrated narrow band interference 28. As will be appreciated by those skilled in the art, in the illustrated embodiment, avalanche transmissions from a plurality of mobile nodes 21b-21c can be viewed as interference at a receiver node when all the superimposed avalanche transmissions cannot be demodulated by this receiver.

Another aspect is directed to a MANET node 21a. The MANET node 25a illustratively includes a wireless transceiver 23a communicating based upon an avalanche communications protocol and with a plurality of other mobile nodes 21b-21c establishing wireless communications links therebetween. The MANET node 21a illustratively includes a decorrelation filter 25a cooperating with the wireless transceiver 23a for reducing the interference from the plurality of other mobile nodes 21b-21c.

Another aspect is directed to a method of operating a MANET 20. The MANET 20 may include a plurality of mobile nodes 21a-21c establishing wireless communications links therebetween. Each mobile node 21a illustratively includes a wireless transceiver 23a, and a decorrelation filter 25a cooperating therewith. The method may include communicating via the plurality of mobile nodes 21a-21c based upon an avalanche communications protocol, and reducing the interference from other mobile nodes with the decorrelation filter 25a.

Advantageously, the MANET 20 communicates using the avalanche communications protocol, which provides greater geographical coverage and path diversity, yet manages to reduce the multipath interference, which may render a typical MANET inoperable.

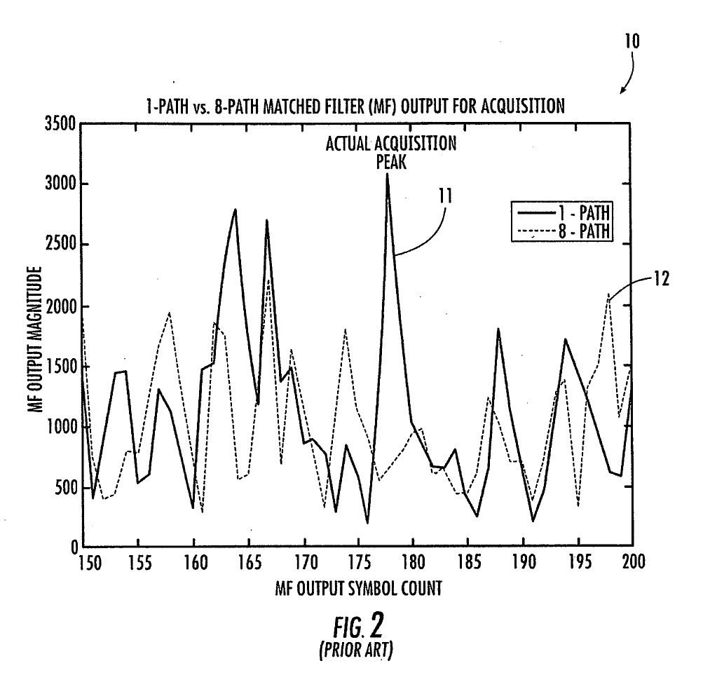

Referring now to FIGS. 2-6, the performance of the above MANET 20 is simulated in an avalanche GMSK communications protocol environment with greater than two or ten mobile nodes and compared with the performance of a typical MANET in a similar environment. More specifically and as will be appreciated by those skilled in the art, this simulated typical MANET is using a matched filter, i.e. a correlator, to facilitate signal detection and reduce interference. Diagram 10 (FIG. 2) includes curves 11-12 illustrating a received signal at a receiver mobile node in the typical MANET. The black curve 11 represents the received signal in a simple one-path environment, i.e. there are only two mobile nodes communicating between each other. The light gray curve 12 represents the received signal in an eight-path environment, i.e. there are at least ten mobile nodes in the MANET. As shown by the curve 12, the receiver mobile node must process up to eight high signal-to-noise ratio (SNR) multipath quasi-aligned signals.

As shown, the eight-path received signal is severely distorted. Indeed, the received signal may be found to be unusable due to excessive multipath, which the receiver cannot handle effectively, causing some of the 8 transmissions to become interference. In other words, the typical MANET with eight-nodes or more may be inoperable when using the avalanche communications protocol. This is due to the limitations of the receiver in exploiting the multiple transmissions.

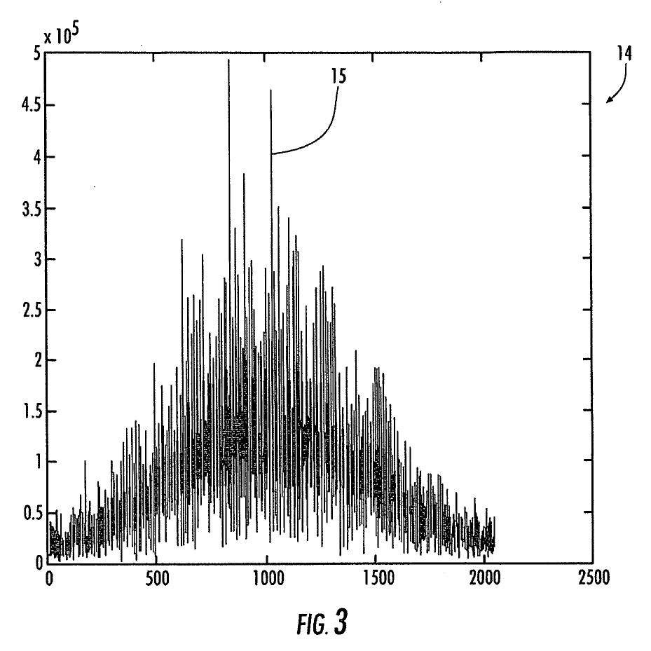

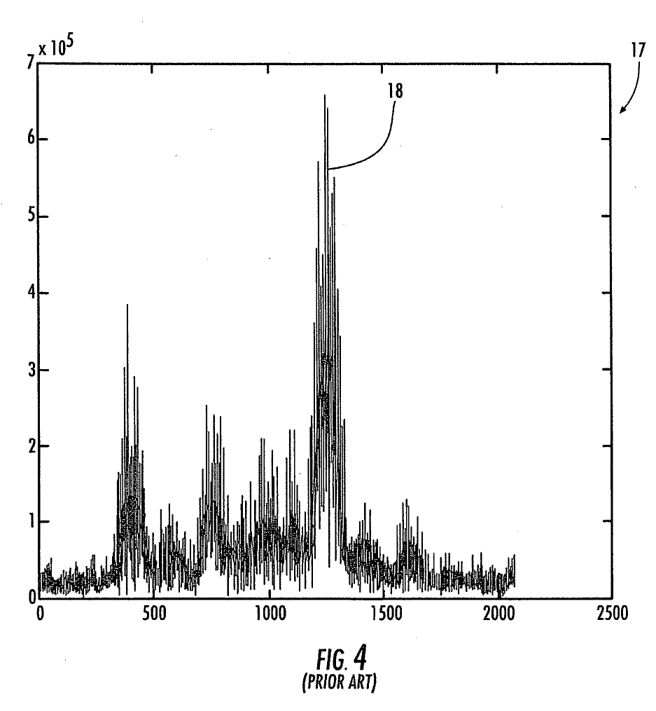

Furthermore, diagram 14 (FIG. 3) includes a data plot 15 for illustrating an ideal baseband received frequency spectrum in the simulated environment for the MANET 20, i.e. only one transmitter. Differently, diagram 17 (FIG. 4) includes a data plot 18 for illustrating the received frequency spectrum in the typical MANET in the eight-path environment, i.e. 8 close to simultaneous relays. The diagram 17 (FIG. 4) again illustrates the significant spectral distortion introduced in the received signal in the typical MANES.

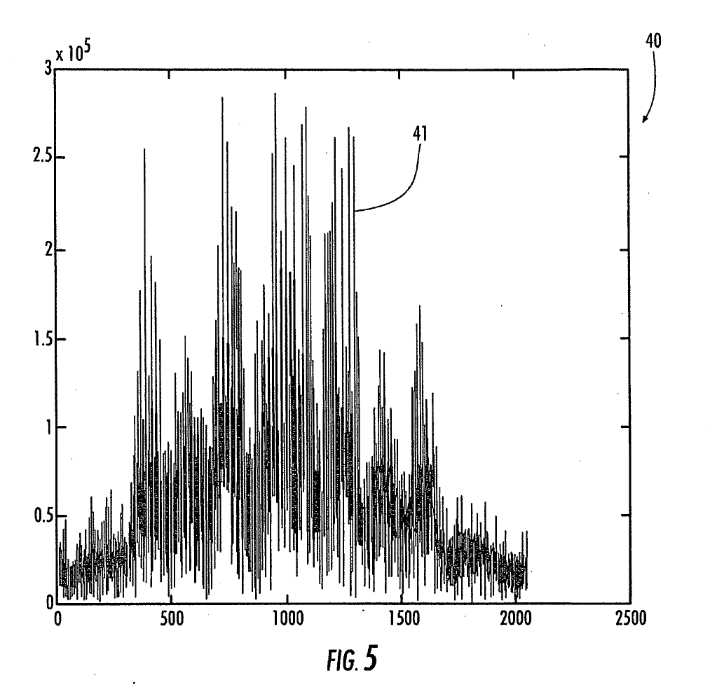

Advantageously, the MANET 20 described above efficiently reduces the significant multi-path interference experienced by the typical MANET. For example, diagram 40 (FIG. 5) includes a data plot 41 for illustrating the received filtered frequency spectrum at the receiver mobile node 21a. As shown, the spectral composition of this signal is closer to the ideal received spectrum, i.e. data plot 15 (FIG. 3).

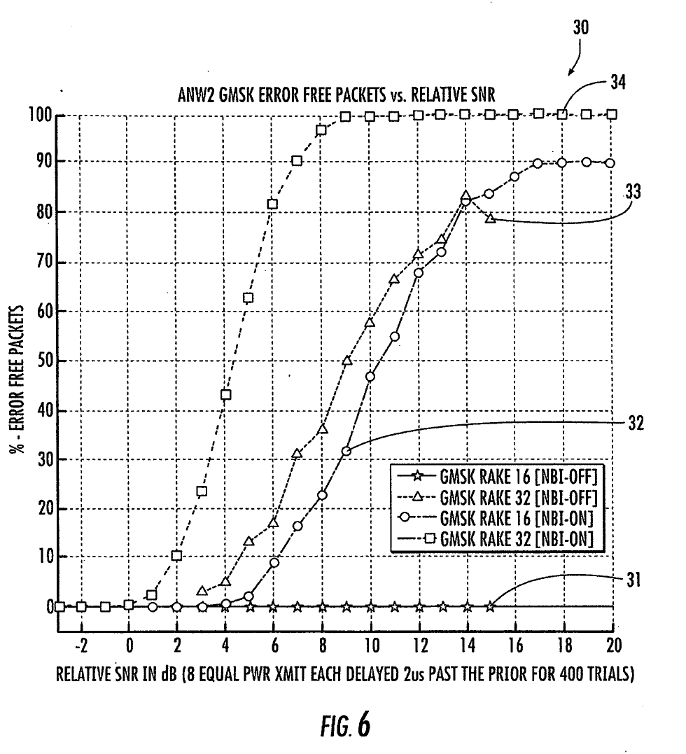

Lastly, diagram 30 (FIG. 6) illustrates the percentage of error free packets received versus SNR ratio for the receiver mobile node in the typical MANET (curves 31, 33) and in the MANET 20 described above (curves 32, 34). As shown, the MANET 20 described herein increases the percentage of error free packets received. Indeed, in the GMSK Rake 16 modulation, the typical MANET was inoperable and the receiver mobile node received zero error free packets.

As shown in the above simulations, the typical MANET may be inoperable in applications where relay nodes number eight or more. Indeed, the above described MANET 20 permits use of the avalanche communications protocol and permits mobile node counts significantly greater than that of the typical MANET, thereby providing greater network coverage and spatial diversity. As will be appreciated by those skilled in the art, depending on the type of waveform used, for example, GMSK Rake 8, GMSK Rake 16, GMSK Rake 32, etc., the number of relay nodes necessary for receiver to malfunction may be less than 8.

Many modifications and other embodiments of the invention will come to the mind of one skilled in the art having the benefit of the teachings presented in the foregoing descriptions and the associated drawings. Therefore, it is understood that the invention is not to be limited to the specific embodiments disclosed, and that modifications and embodiments are intended to be included within the scope of the appended claims.

What which is claimed is:

1. A mobile ad-hoc network (MANET) comprising:
a plurality of mobile nodes establishing wireless communications links therebetween, said plurality of mobile nodes communicating based upon a relay communications protocol;
each mobile node comprising a wireless transceiver, and a decorrelation filter cooperating therewith for reducing interference from other mobile nodes.

2. The MANET according to claim 1 wherein each mobile node communicates based upon an avalanche communications protocol.

3. The MANET according to claim 1 wherein said decorrelation filter comprises an adaptive decorrelation filter.

4. The MANET according to claim 1 wherein said decorrelation filter also reduces multi-path interference from other mobile nodes.

5. The MANET according to claim 1 wherein said decorrelation filter also filters narrow band interference from other sources.

6. The MANET according to claim 1 wherein each mobile node further comprises a downconverter upstream from said decorrelation filter for converting a received signal into a baseband signal.

7. The MANET according to claim 1 wherein each mobile node further comprises a demodulator downstream from said decorrelation filter.

8. The MANET according to claim 1 wherein each mobile node communicates based upon a Gaussian minimum shift keying (GMSK) protocol.

9. The MANET according to claim 1 wherein each mobile node communicates based upon at least one of a voice relay protocol and a data relay protocol.

10. A mobile ad-hoc network (MANET) comprising:
a plurality of mobile nodes establishing wireless communications links therebetween, said plurality of mobile nodes communicating based upon an avalanche communications protocol;
each mobile node comprising a wireless transceiver, and an adaptive decorrelation filter cooperating therewith for reducing at least multi-path interference from other mobile nodes.

11. The MANET according to claim 10 wherein said adaptive decorrelation filter also filters narrow band interference from other sources.

12. The MANET according to claim 10 wherein each mobile node further comprises a downconverter upstream from said adaptive decorrelation filter for converting a received signal into a baseband signal.

13. The MANET according to claim 10 wherein each mobile node further comprises a demodulator downstream from said adaptive decorrelation filter.

14. A mobile ad-hoc network (MANET) node comprising:
a wireless transceiver communicating based upon a relay communications protocol and with a plurality of other mobile nodes establishing wireless communications links therebetween; and
a decorrelation filter cooperating with said wireless transceiver for reducing interference from the plurality of other mobile nodes.

15. The MANET node according to claim 14 wherein said wireless transceiver communicates based upon an avalanche communications protocol.

16. The MANET node according to claim 14 wherein said decorrelation filter comprises an adaptive decorrelation filter.

17. The MANET node according to claim 14 wherein said decorrelation filter also reduces multi-path interference from other mobile nodes.

18. The MANET node according to claim 14 wherein said decorrelation filter also filters narrow band interference from other sources.

19. A method of operating a mobile ad-hoc network (MANET) comprising a plurality of mobile nodes establishing wireless communications links therebetween, each mobile node comprising a wireless transceiver, and a decorrelation filter cooperating therewith, the method comprising:
communicating via the plurality of mobile nodes based upon a relay communications protocol; and
reducing interference from other mobile nodes with the decorrelation filter.

20. The method according to claim 19 further comprising communicating via the plurality of mobile nodes based upon an avalanche communications protocol.

21. The method according to claim 19 wherein the decorrelation filter comprises an adaptive decorrelation filter.

22. The method according to claim 19 further comprising using the decorrelation filter for reducing multi-path interference from other mobile nodes.

23. The method according to claim 19 further comprising using the decorrelation filter for filtering narrow band interference from other sources.
